(19) United States
(12) Patent Application Publication
(10) Pub. No.: US 2023/0229904 A1
(43) Pub. Date: Jul. 20, 2023

(54) TRANSFER LEARNING THROUGH COMPOSITE MODEL SLICING

(71) Applicant: INTERNATIONAL BUSINESS MACHINES CORPORATION, Armonk, NY (US)

(72) Inventors: Sathya Santhar, Chennai (IN); Sarbajit K. Rakshit, Kolkata (IN); Sridevi Kannan, Chennai (IN); Samuel Mathew Jawaharlal, Chennai (IN)

(21) Appl. No.: 17/568,209

(22) Filed: Jan. 4, 2022

(51) Int. Cl. G06N 3/08; G06N 3/04; G06K 9/62

(52) U.S. Cl. CPC G06N 3/08; G06K 9/6201; G06N 3/0454

(57) ABSTRACT

A method includes receiving model data, training a plurality of supervised models using the model data, each of the plurality of supervised models including a plurality of layers, slicing each of the plurality of supervised models into individual layers of the plurality of layers, calculating accuracy of feature detection of each of the individual layers of each of the plurality of supervised models, and combining a sequence of the individual layers taken from different models of the plurality of supervised models into a composite model based on the calculated accuracy of feature detection of each of the individual layers of each of the plurality of supervised models.

### BACKGROUND

The present invention relates to supervised models for machine learning. More specifically, the invention relates to transfer learning techniques for supervised models for convolutional neural networks through composite model slicing at layers of a model.

A convolutional neural network (CNN) is a deep learning algorithm that can take an input image, assign importance (learnable weights and biases) to various aspects and objects in the image and be able to differentiate one aspect or object from the other. CNNs have proven their advantage as a deep learning model in a variety of applications. When handling large data sets to extract features and make predictions, the CNN models have always shown their competency. To increase model accuracy and reduce the generalization error, various methods have been proposed, such as pre-processing, batch-normalization, dropout, ensemble learning, and deeper CNNs.

However, increasing model accuracy and reducing the generalization error without ignoring computational cost would be well received in the art.

### SUMMARY

An embodiment of the present invention relates to a method, and associated computer system and computer program product, for transfer learning through composite model slicing. In accordance with the method one or more processors of a computer system receive model data and train a plurality of supervised models using the model data, each of the plurality of supervised models including a plurality of layers. The one or more processors of the computer system slice each of the plurality of supervised models into individual layers of the plurality of layers and calculate accuracy of feature detection of each of the individual layers of each of the plurality of supervised models. The one or more processors of the computer system combine a sequence of the individual layers taken from different models of the plurality of supervised models into a composite model based on the calculated accuracy of feature detection of each of the individual layers of each of the plurality of supervised models.

### BRIEF DESCRIPTION OF THE DRAWINGS

FIG. 1 depicts a system for transfer learning through composite model slicing, in accordance with embodiments of the present invention.

FIG. 2 depicts a visualization for a CNN model, in accordance with embodiments of the present invention.

FIG. 3A depicts a first portion of a slicing architecture for the CNN model of FIG. 2, in accordance with embodiments of the present invention.

FIG. 3B depicts a second portion of the slicing architecture for the CNN model of FIG. 2, in accordance with embodiments of the present invention.

FIG. 3C depicts a third portion of the slicing architecture for the CNN model of FIG. 2, in accordance with embodiments of the present invention.

FIG. 4 depicts a feature class matrix of one supervised model after processing trained data across a plurality of layers, in accordance with embodiments of the present invention.

FIG. 5 depicts a decision tree network for predicting an eye feature class with high accuracy, in accordance with embodiments of the present invention.

FIG. 6 depicts a composite model comprising layers from a plurality of different types of models, in accordance with embodiments of the present invention.

FIG. 7 depicts a method for transfer learning through composite model slicing, in accordance with embodiments of the present invention.

FIG. 8 depicts a block diagram of a computer system for the system for transfer learning through composite model slicing of FIG. 1, capable of implementing methods such as those of FIG. 7, in accordance with embodiments of the present invention.

FIG. 9 depicts a cloud computing environment, in accordance with embodiments of the present invention.

FIG. 10 depicts abstraction model layers, in accordance with embodiments of the present invention.

### DETAILED DESCRIPTION

CNNs are nonlinear methods and offer increased flexibility and can scale in proportion to the amount of training data available. CNNs learn via a stochastic training algorithm, which means that they are sensitive to the specifics of the training data and may find a different set of weights each time they are trained, which in turn produce different predictions every time. Generally, this is referred to as CNNs having a high variance. High variance is not desired when trying to develop a final model to use for making predictions. A fully connected layer occupies most of the parameters, and hence, neurons develop co-dependency amongst each other during training which curbs the individual power of each neuron leading to over-fitting of training data. Various methods, such as ensemble learning and deeper networks, have been used to reduce the error and variance of CNNs.

Ensemble learning is a successful approach to reducing the variance of neural network models. Ensemble learning trains multiple models instead of a single model and to combine the predictions from these models. This not only reduces the variance of predictions but also can result in predictions that are better than any single model. With ensemble learning, every individual model will give its prediction and the final prediction of the ensemble model will be the most frequent prediction by all the individual CNN models. Ensemble techniques require the additional computational expense of training and maintaining the multiple models. Additionally, the best layer of the model contributing to the overall improved accuracy is not found leading to unnecessary usage of a major portion of other models.

Deeper models (also referred to as inception networks) will convolve m ore of the input data. When a network does a convolution on an input, it extracts a relevant feature (mostly the edges, shapes, colors, etc). Allowing the network to perform more convolutions let it extract with more precision the features its “judges” relevant according to the dataset. Here, the accuracy of the features is not measured from the middle layers of the network. The accuracy and error rate measurement at each layer gives insight about finding the most significant layer until there has been steady increase in accuracy.

The problem in both the cases is that the process of increasing the model accuracy requires additional computational cost (ensemble learning) or the most significant layer of the model is not found (inception networks) which can be picked up and used further to improve the performance of the model.

The present invention seeks to improve the accuracy of CNN performance by resolving the above mentioned problems. To increase the model accuracy and performance without compromising on the computation, the present invention proposes a method of finding the best layer in the model which contributes to the steady increase in accuracy. The present invention recognizes that it is important to understand at which layers of a model the accuracy increases; and from which point the accuracy starts to decline or plateaus.

The present invention proposes a system where multiple supervised models, once trained, are sliced at each layer taking the output from the attention layers. These slices are fed to a shallow neural network which takes the inputs from the sliced portion of the network and outputs the multiple classes of different features that contribute to the detection of the overall object. The independent features are determined, and accuracy is calculated for each of these features after every slice. The features with high accuracy across heterogenous model slices are picked and concatenated in sequence of low level to high level features. The overall accuracy of the final model is contributed by individual accuracies of each slice that are connected together. The slices can be from models of same type, or from different types of supervised models (such as CNN models and decision tree models). If the slices are from the same type of models, the output of one slice is reshaped to feed into the input of another slice. Once the slices are stacked together to form a composite model, transfer learning technique may be deployed to pick the best features from different slices to produce the output class with greater accuracy. The overall accuracy of the composite model is compared with the accuracy of the individual models from where the slices are taken and also with the slices of the composite model to make sure the right slices are taken and concatenated.

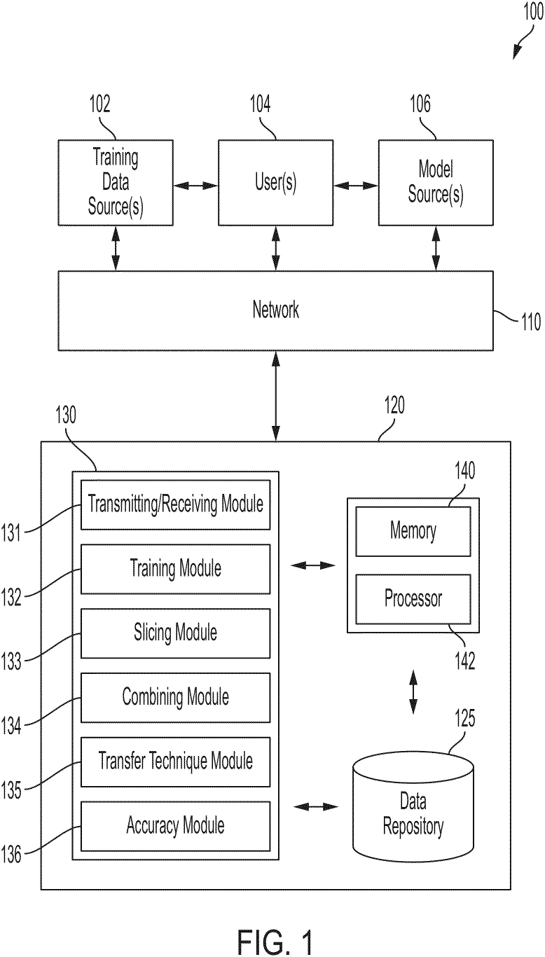

FIG. 1 depicts a system for transfer learning through composite model slicing 100, in accordance with embodiments of the present invention. The system for transfer learning through composite model slicing 100 may include training data source(s) 102, user(s) 104, and model source(s) 106 connected or otherwise communicatively coupled over a network 110 to a computer system 120. The training data source(s) 102, user(s) 104, and model source(s) 106 are further shown connected to each other. The training data source(s) 102, user(s) 104, and model source(s) 106 may represent one or more training data sources, users, and model sources. The training data source(s) 102 may be data sources used to train a CNN or other supervised model, and may be provided to the computer system 120 by the user(s) 104, or independently provided to the computer system 120. In some embodiments, the computer system 120 may include its own training data, obviating the need for an outside source of training data such as the training data source(s) 102. The user(s) 104 may be any user which may be configured to interact with the computer system 120 to supervise the training of the models and the creation of a composite model, as described herein. Like the training data source(s) 102, the model source(s) 106 may be provided to the computer system 120 by the user(s) 104, or independently provided to the computer system 120, or may be already incorporated into the computer system 120 without the need of an outside source.

The network 110 may refer to a group of two or more computer systems linked together. Network 110 may be any type of computer network known by individuals skilled in the art. Examples of computer networks 110 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 110 may be a peer-to-peer network in some embodiments, wherein in other embodiments, the network 110 may be organized as a client/server architecture.

Embodiments of the computer system 120 may include a module structure 130 that includes a receiving and transmitting module 131, a training module 132, a slicing module 133, a combining module 134, a transfer technique module 135, and an accuracy module 136. A “module” may refer to a hardware-based module, software-based module or a module may be a combination of hardware and software. Embodiments of hardware-based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines. The modules may each be separate components of the computer system 120. In other embodiments, more than one module may be a single combined computer program, or hardware module. Moreover, the computer system 120 may be a module portion of another computer system server, or computer infrastructure in some embodiments.

Embodiments of the receiving and transmitting module 131 may include one or more components of hardware and/or software program code for obtaining, retrieving, collecting, or otherwise receiving information from the user(s) 104, training data source(s) 102, and model source(s) 106, as well as transmitting thereto. The receiving and transmitting module 131 may be configured to receive, for example, training inputs such as model data, as well as modeling algorithms for various different models. The receiving and transmitting module 131 may be configured to allow for communication with one or more model supervisors such as the user(s) 104, including outputting the various composite model to the user(s) 104, or outputting the results of running actual data through the composite model to the user(s) 104, once the composite model is trained in accordance with the methods described herein.

Referring still to FIG. 1, embodiments of the computer system 120 may further include the training module 132. Embodiments of the training module 132 may include one or more components of hardware and/or software program code configured for training a plurality of supervised models using the model data received by the receiving module 131. The plurality of supervised models may each include a plurality of layers, as described hereinbelow. Further, the plurality of supervised models may include models of different types, such as CNN models, decision tree models, deep CNN models or the like.

Embodiments of the slicing module 133 may include one or more components of hardware and/or software program code for slicing an individual model into individual layers of the plurality of layers that comprise the individual model. The slicing module 133 may be configured to slice layers by an image feature, in the case that the models are image recognition models. Further, the layers may be more or less specific, depending on the application, needs and requirements. For example, a layer be configured to detect texture, while the texture layer may be further sliced into sub layers for detecting a specific type of texture, as in a smooth texture, a curl pattern or the like.

Embodiments of the combining module 134 may include one or more components of hardware and/or software program code for combining a sequence of the individual layers taken from different models of the plurality of supervised models into a composite model based on the calculated accuracy of feature detection of each of the individual layers of each of the plurality of supervised models. The combining module 134 may be configured to concatenate the sequence of the individual layers in an order that begins with low level features and ends with high level features. In the event the models are different between sequential layers of the composite model, the combining module 134 may be configured to combine such that an output of a previous layer of the sequence of individual layers is not connected directly to an input of a next layer of the sequence of individual layers during training but is connected after the previous layer and the next layer are trained separately. In the event that the models are the same between sequential layers of the composite model, the combining module 134 may be configured to combine such that the layers are directly connected after reshaping the outputs of previous slice to match with the inputs of the next slice.

Embodiments of the transfer technique module 135 may include one or more components of hardware and/or software program code for assisting in picking the best features from the different slices combined by the combining module 134 to produce an output class with greater accuracy. In other words, the transfer technique module 135 may take knowledge retained from the generation of other composite models, to help increase accuracy of the composite model. The transfer technique module 135 may further take past acquired knowledge from other composite model creations in order to pick the individual layers used by the combining module 134 to create the composite module. The transfer technique module 135 may further be configured to provide slice-based transfer learning to improve the various other individual models provided for creating the composite model.

Embodiments of the accuracy module 136 may include one or more components of hardware and/or software program code for comparing accuracy of the composite model relative to the accuracy of the individual models used to generate the composite model based on the processes described herein. Thus, the accuracy module 136 may be configured to safeguard errors in the composite module creation and ensure that the overall composite module is more accurate than the constituent individual models used to generate the composite module.

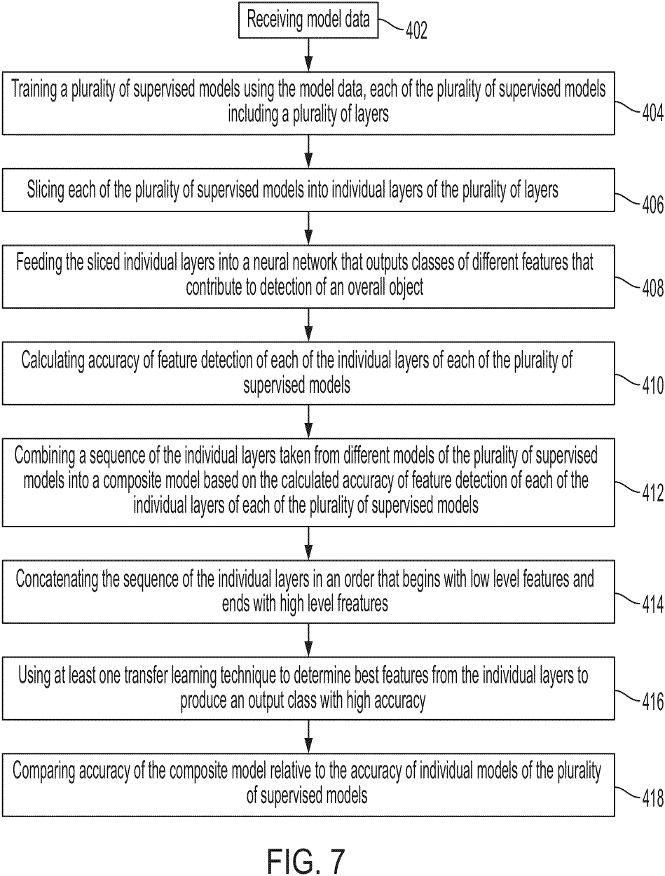

Referring still to FIG. 7, embodiments of the computer system 120 may be equipped with a memory device 140 and a processor 142. The memory device 140 may store the information needed by a processor 142 to perform operations thereof. The processor 142 may be configured for implementing the tasks associated with the computer system 120, described hereinabove. The computer system 120 further includes a data repository 125. The data repository can store information received by the training data source(s) 102, user(s) 104, and model source(s) 106, as appropriate for use by the module structure 130. Further, the data repository 125 may include its own stored models and/or training data so that outsides sources for such information is not necessary.

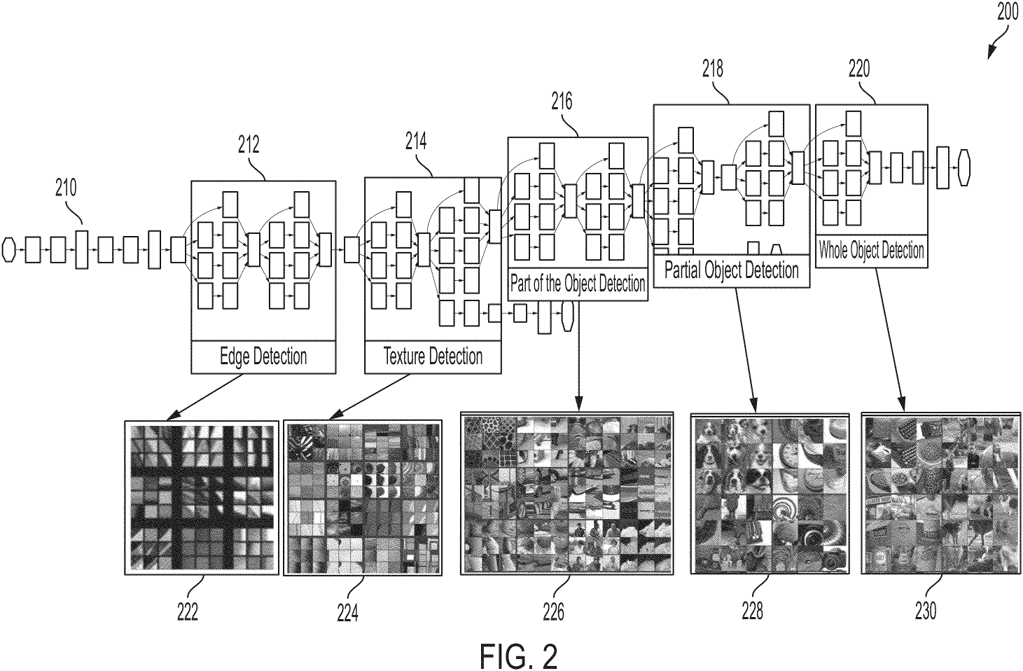

FIG. 2 depicts a visualization for a CNN model 200, in accordance with embodiments of the present invention. The CNN model includes multiple layers 210, 212, 214, 216, 218, 220 assembled together to provide a multi-class output. As shown in the visualization are various image features 222, 224, 226, 228, 230 which correspond to the various layers 212, 214, 216, 218, 220, respectively. For example, the first layer 210 may be a data receiving, organization and/or formatting layer, followed by an edge detection layer 212, followed by a texture detection layer 214, followed by a part of the object detection layer 216, followed by a partial object detection layer 218, followed by a whole object detection layer 220, followed by output steps 221 of the CNN model 200.

The initial low-level features such as the edges 222 and the textures 224 of the images are detected by the first set of layers, i.e. the edge detection 212 and texture detection 214 layers, respectively. The layers continue to sequentially with more specific features (i.e. higher level layers 216, 218, 220) until the CNN model 200 can predict all the features of the image. In the embodiment shown, different CNN techniques may be applied for each level. For example, the edge detection layer 212 can detect edges either by Gaussian method or Laplacian method. Filters like a sobel filter can detect edges pretty much accurately. In a deep neural network, the edges can also be detected by multiple layers with each layer individual layer (using additional sublayers as described hereinbelow) focusing on different types of edges like vertical edges, horizontal edges and diagonal edges. The below diagram shows clearly how each set of network slices can contribute to different features in an image.

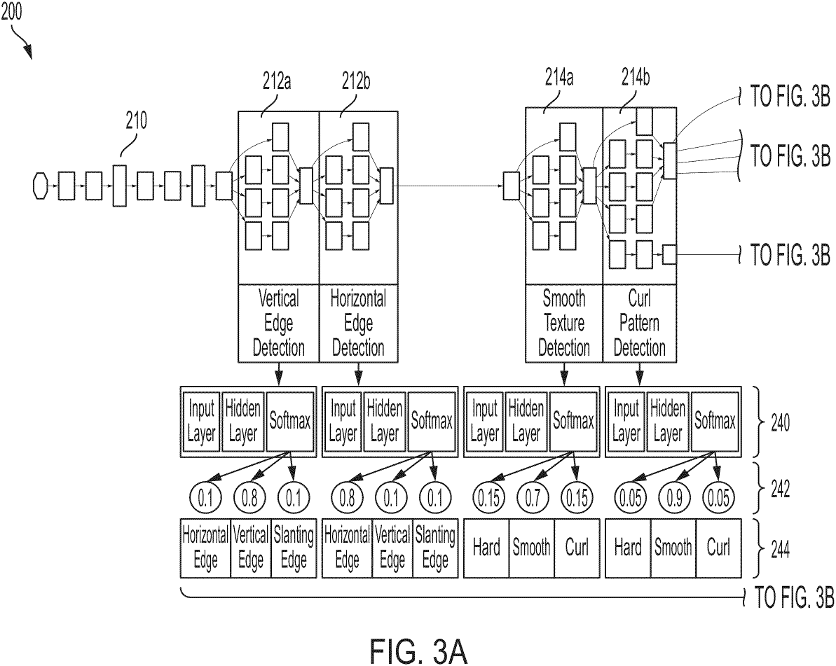

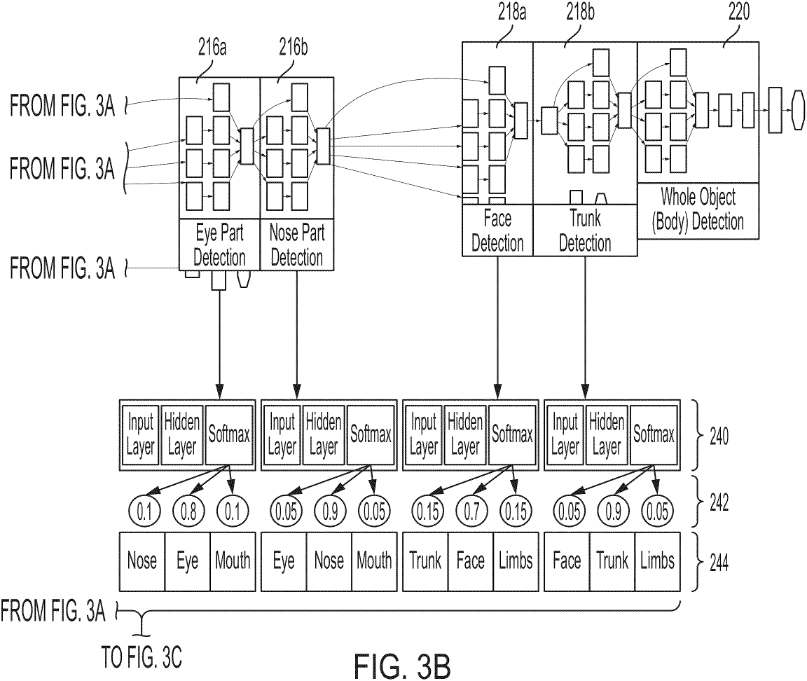

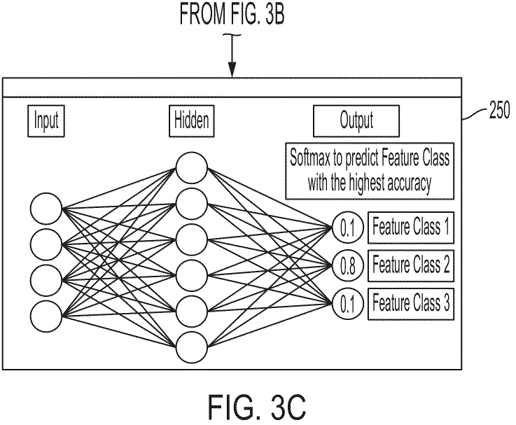

FIGS. 3A-C depicts portions of another slicing architecture for the CNN model 200 of FIG. 2, in accordance with embodiments of the present invention. Here, the CNN model slices the layers 212, 214, 216, 218, described hereinabove, further into sublayers 212a, 212b, 214a, 214b, 216a, 216b, 218a, 218b. In particular, the edge detection layer 212 is divided into a vertical edge detection sublayer 212a and a horizontal edge detection sublayer 212b. The texture detection layer 214 is divided into a smooth texture detection sublayer 214a and a curl pattern detection sublayer 214b. The part of the object detection layer 216 is divided into an eye part detection sublayer 216a and a nose part detection sublayer 216b. The partial object detection layer 218 is divided into a face detection sublayer 218a and a trunk detection sublayer 218b.

The CNN model 200 of the present invention identifies the different model slices that are good at performing different functionalities. Even though the overall model accuracy of the CNN model 200 conveys how accurate the model prediction is, the CNN model 200 taken alone would not normally convey the level of accuracy for each feature. For example, the CNN model 200 model might have overall accuracy of detecting dogs and cats as 75% but the first 3 layers might be very good at detecting horizontal edges with 90% accuracy. The later layers of the model might be having less accuracy for detecting other features like diagonal edges and so on. The present invention provides a way to identify which part of the model is good at predicting which feature. Specifically, in the present invention, the CNN model 200 is examined for accuracy on the layer and sublayer levels.

This layer and sublayer accuracy examination begins with creating a multi class output with the features (e.g. vertical edges, horizontal edges, smooth textures, curl patterns, eye parts, nose parts, faces, trunks and whole objects, as shown) that are required to be extracted or need to be transferred. From each activation layer or sublayer 212a, 212b, 214a, 214b, 216a, 216b, 218a, 218b of the deep neural network, a sliced output is taken and fed to one or more small neural networks 250 with limited layers 240 (e.g, an input layer, at least one hidden layer, and then a softmax layer) to provided prediction probability results 242 (e.g. on a scale between 0 and 1) for the feature classes 244 needed. This processing may be conducted by the computer system 120 in order to identify the accuracy of individual features predicted across all layers.

For example, this processing may result in 3rd layer predicting edges with higher accuracy after which the accuracy may not increase even if the model goes through other layers, while a 5th layer might be good at predicting saturation levels better. Examining the model on a layer or sublayer basis in this manner may be conducted using supervised learning samples once the entire model is trained completely.

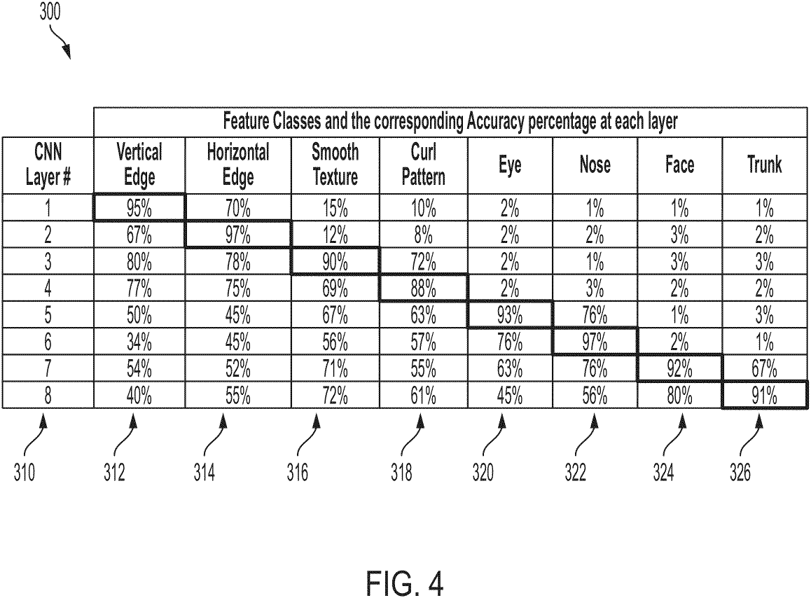

FIG. 4 depicts a feature class matrix 300 of one supervised model after processing trained data across a plurality of layers 1 - 8, in accordance with embodiments of the present invention. The feature class matrix 300 plots data related to the rows of the individual CNN layer numbers 310 (i.e. CNN layers 1 - 8) across various feature classes represented by columns 312, 314, 316, 318, 320, 322, 324, 326. Specifically, a first column 312 represents data related to a vertical edge feature class. A second column 314 represents data related to a horizontal edge feature class. A third column 316 represents data related to a smooth texture feature class. A fourth column 318 represents data related to a curl pattern feature class. A fifth column 320 represents data related to an eye feature class. A sixth column 322 represents data related to a nose feature class. A seventh column 324 represents data related to a face feature class. An eighth column 326 represents data related to a trunk feature class. It should be understood that a separate feature class matrix may be created for each of the various models of the plurality of different individual models that are processed by the computer system 120 in compiling a composite model, as described herein. That shown in FIG. 4 is an exemplary feature class matrix for a single one of these individual models, such as the CNN model 200. The feature class matrix 300 thereby provide the computer system 120 information on the logical point of slicing to pick the right slices for the final composite model, which would result in increased overall accuracy.

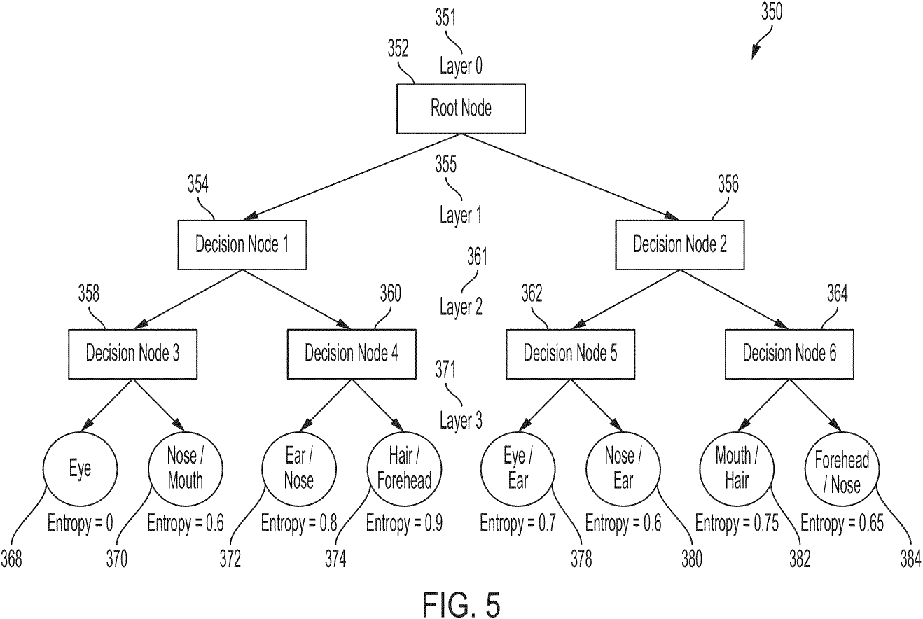

FIG. 5 depicts a decision tree network 350 for predicting an eye feature class with high accuracy, in accordance with embodiments of the present invention. As shown, the present invention contemplates taking slices from models of the same type or of different types. For example, n layers can be taken from one CNN and m layers can be taken from another CNN or m layers can come form a decision tree, such as the decision tree network 350. The decision tree network 350 is an example of a decision tree which is good at predicting certain features of a class. A trained decision tree may be good at detecting the fruits when another other model can detect the edges in the image. Such edge detection can help the decision tree to start with the edges already predicted, as a decision tree might be bad in predicting edges. The decision tree network 350 may include a plurality of layers 351, 355, 361, 371. The decision tree network 350 may include a root node 352 breaking into two decision nodes 354, 356. The two decision nodes break into four separate decision sub-nodes 358, 360, 362, 364. A final layer provides for the entropy levels of the various features, such as eye 368, nose/mouth 370, ear/nose 372, hair/forehead 374, eye/ear 376, nose/ear 378, mouth/hair 380 and forehead/nose 382. The entropy (disorder) of the model is lowest for the detection of the eye feature 368, and so the decision tree network 350 is very good at detecting this feature.

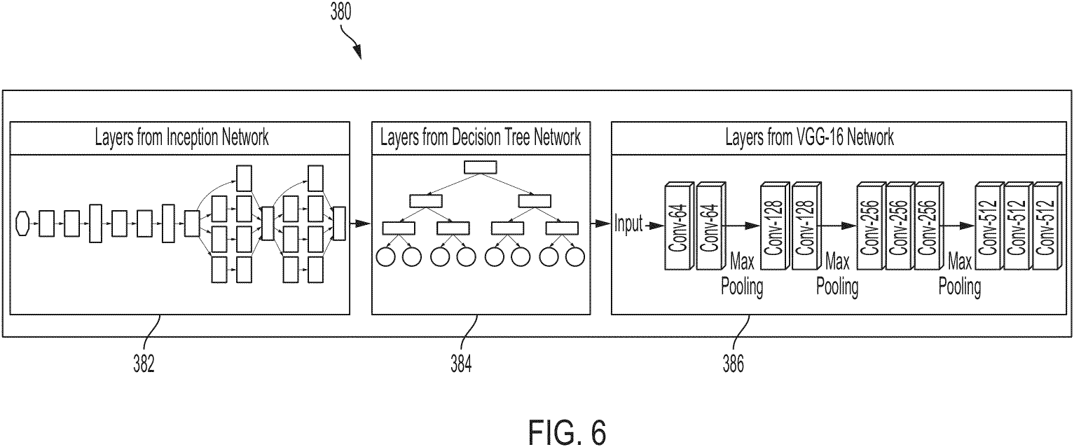

FIG. 6 depicts a composite model 380 comprising layers from a plurality of different types of models, in accordance with embodiments of the present invention. The composite model 380 shows an ensembling technique where slices from different models 382, 384, 386 which are good at predicting a particular feature is picked and assembled and then the entire composite model 380 is trained using a transfer learning technique. If all the components of the composite model are of the same type (not shown), they may be directly connected after reshaping the outputs of previous slice to match with the inputs of the next slice. For example, if all the components of the composite model are CNN models of the same type, such layers may be directly connected to match outputs of one layer as inputs of the next slice. If the components are of different type (as shown), then the output of previous slice is not connected directly to the input of the next slice during training, but they may be connected after each component is trained separately. As shown, the composite model 380 includes slices from three separate models 382, 384, 386. In particular, the composite model 380 includes a lower level initial layers from an inception CNN network 382. Next, the composite model 380 includes layers from a decision tree network 384. Finally, the composite model 380 includes layers from a deep CNN network 386. The composite model 380 is meant to be exemplary, and the present invention contemplates any number of slices, ordering, and model combinations for a composite network.

FIG. 7 depicts a method 400 for transfer learning through composite model slicing, in accordance with embodiments of the present invention. The method 400 includes a first step 402 of receiving, by one or more processors of a computer system such as the computer system 120, model data. The model data may be received from an internal data repository, such as the data repository 125, or by an outside source such as the training data source(s) 102 or the user(s) 104. The method 400 includes a next step 404 of training, by the one or more processors of the computer system, a plurality of supervised models such as the supervised model 200 or the decision tree model 350, using the model data, each of the plurality of supervised models including a plurality of layers. The method 400 includes a next step 406 of slicing, by the one or more processors of the computer system, each of the plurality of supervised models into individual layers of the plurality of layers, such as the individual layers 212a, 212b, 214a, 214b, 216a, 216b, 218a, 218b, 220 of the supervised model 200 or the layers 351, 355, 361, 371 of the supervised model 350.

The method 400 may include a step 408 of feeding, by the one or more processors of the computer system, the sliced individual layers into a neural network, such as the module structure 130 of the computer system 120, that outputs classes of different features that contribute to detection of an overall object. The method 400 includes a step 410 of calculating, by the one or more processors of the computer system, accuracy of feature detection of each of the individual layers of each of the plurality of supervised models, such as by creating a feature class matrix such as the feature class matrix 300.

The method 400 includes a step 412 of combining, by the one or more processors of the computer system, a sequence of the individual layers taken from different models of the plurality of supervised models, such as the different models 200, 350, 382, 384, 386, into a composite model, such as the composite model 380, based on the calculated accuracy of feature detection of each of the individual layers of each of the plurality of supervised models. In the event the models are different between sequential layers of the composite model, the combining may be performed such that an output of a previous layer of the sequence of individual layers is not connected directly to an input of a next layer of the sequence of individual layers during training but is connected after the previous layer and the next layer are trained separately. In the event that the models are the same between sequential layers of the composite model, the combining may be performed such that the layers are directly connected after reshaping the outputs of previous slice to match with the inputs of the next slice.

The method 400 includes a step 414 of concatenating, by the one or more processors of the computer system, the sequence of the individual layers in an order that begins with low level features and ends with high level features. The method 400 further includes a step 416 of using at least one transfer learning technique, by the one or more computer processors of the computer system, to determine best features from the individual layers to produce an output class with high accuracy. Finally, the method 400 includes a step 418 of comparing, by the one or more processors of the computer system, accuracy of the composite model relative to the accuracy of individual models of the plurality of supervised models.

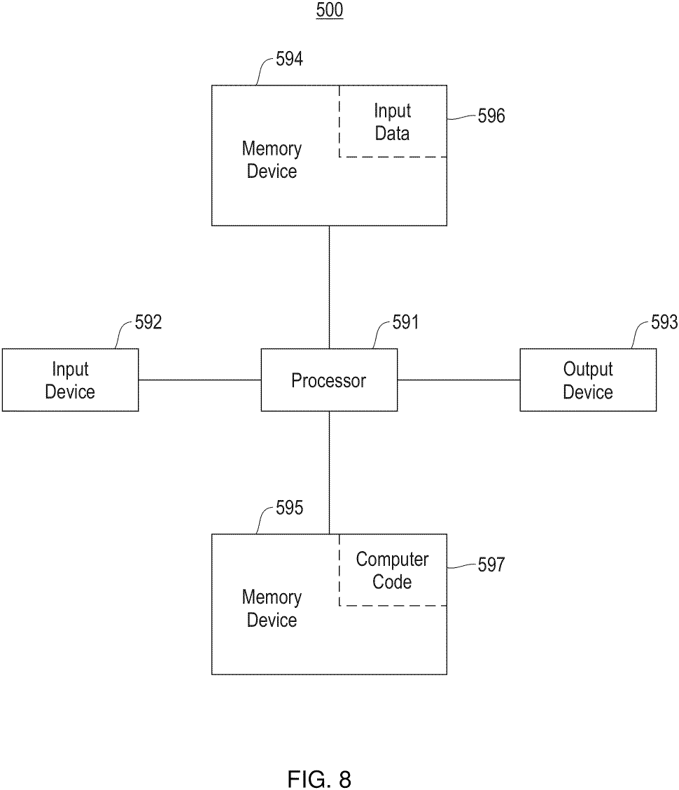

FIG. 8 depicts a block diagram of a computer system which represents any computer system shown in the system for transfer learning through composite model slicing of FIG. 1, capable of implementing methods such as those of FIG. 7, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing methods for transfer learning through composite model slicing, in the manner prescribed by the embodiments of FIG. 7 using the system for transfer learning through composite model slicing of FIG. 1, wherein the instructions of the computer code 597 may be executed by processor 591 via memory device 595. The computer code 597 may include software or program instructions that may implement one or more algorithms for implementing the methods for transfer learning through composite model slicing, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

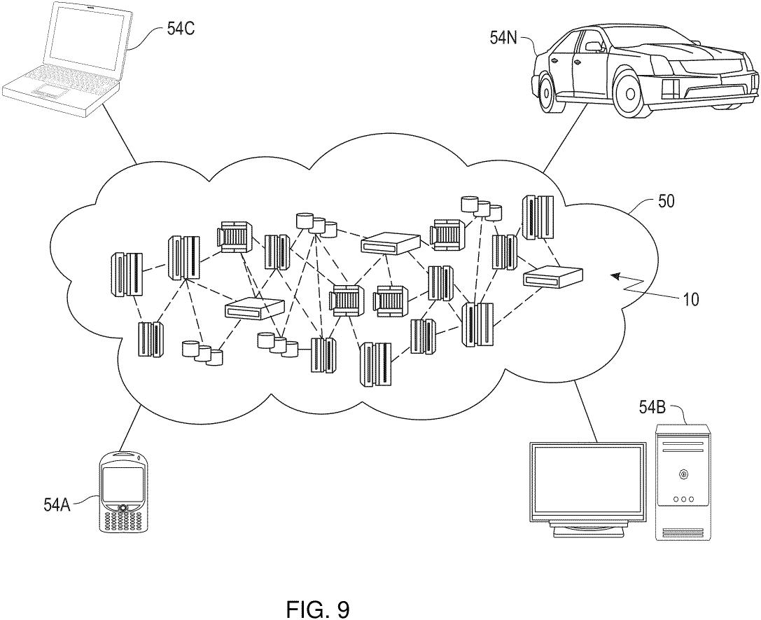

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 9.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for transfer learning through composite model slicing. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide a system for transfer learning through composite model slicing. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for transfer learning through composite model slicing. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for transfer learning through composite model slicing.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

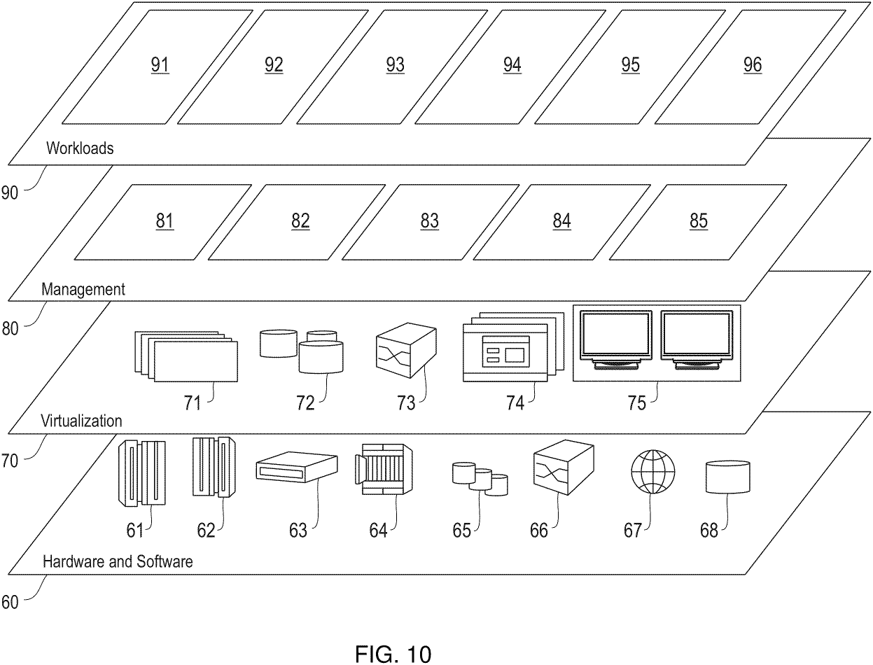

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 10 are intended to be illustrative only and that computing nodes 10 and cloud computing environment 50 can communicate with any type of computerized device over any type of network and/or network addressable connection (e.g., using a web browser).

Referring now to FIG. 10, a set of functional abstraction layers provided by cloud computing environment 50 (see FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: sending and receiving 91; training 92; slicing 93; combining 94; transfer technique 95; and accuracy 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving, by one or more processors of a computer system, model data;
training, by the one or more processors of the computer system, a plurality of supervised models using the model data, each of the plurality of supervised models including a plurality of layers;
slicing, by the one or more processors of the computer system, each of the plurality of supervised models into individual layers of the plurality of layers;
calculating, by the one or more processors of the computer system, accuracy of feature detection of each of the individual layers of each of the plurality of supervised models; and
combining, by the one or more processors of the computer system, a sequence of the individual layers taken from different models of the plurality of supervised models into a composite model based on the calculated accuracy of feature detection of each of the individual layers of each of the plurality of supervised models.

2. The method of claim 1, further comprising:
feeding, by the one or more processors of the computer system, the sliced individual layers into a neural network that outputs classes of different features that contribute to detection of an overall object.

3. The method of claim 1, wherein the combining further comprises:
concatenating, by the one or more processors of the computer system, the sequence of the individual layers in an order that begins with low level features and ends with high level features.

4. The method of claim 1, wherein the plurality of supervised models comprises different types of models.

5. The method of claim 4, wherein the combining further comprises:
combining, by the one or more processors of the computer system, the sequence of the individual layers from different types of models such that an output of a previous layer of the sequence of individual layers is not connected directly to an input of a next layer of the sequence of individual layers during training but is connected after the previous layer and the next layer are trained separately.

6. The method of claim 1, wherein the combining further comprises:
using at least one transfer learning technique, by the one or more computer processors of the computer system, to determine best features from the individual layers to produce an output class with high accuracy.

7. The method of claim 1, further comprising:
comparing, by the one or more processors of the computer system, accuracy of the composite model relative to the accuracy of individual models of the plurality of supervised models.

8. A computer system, comprising:
one or more processors;
one or more memory devices coupled to the one or more processors; and
one or more computer readable storage devices coupled to the one or more processors, wherein the one or more storage devices contain program code executable by the one or more processors via the one or more memory devices to implement a method for transfer learning through composite model slicing, the method comprising:
receiving, by the one or more processors of the computer system, model data;
training, by the one or more processors of the computer system, a plurality of supervised models using the model data, each of the plurality of supervised models including a plurality of layers;
slicing, by the one or more processors of the computer system, each of the plurality of supervised models into individual layers of the plurality of layers;
calculating, by the one or more processors of the computer system, accuracy of feature detection of each of the individual layers of each of the plurality of supervised models; and
combining, by the one or more processors of the computer system, a sequence of the individual layers taken from different models of the plurality of supervised models into a composite model based on the calculated accuracy of feature detection of each of the individual layers of each of the plurality of supervised models.

9. The computer system of claim 8, the method further comprising:
feeding, by the one or more processors of the computer system, the sliced individual layers into a neural network that outputs classes of different features that contribute to detection of an overall object.

10. The computer system of claim 8, wherein the combining further comprises:
concatenating, by the one or more processors of the computer system, the sequence of the individual layers in an order that begins with low level features and ends with high level features.

11. The computer system of claim 8, wherein the plurality of supervised models comprises different types of models.

12. The computer system of claim 11, wherein the combining further comprises:
combining, by the one or more processors of the computer system, the sequence of the individual layers from different types of models such that an output of a previous layer of the sequence of individual layers is not connected directly to an input of a next layer of the sequence of individual layers during training but is connected after the previous layer and the next layer are trained separately.

13. The computer system of claim 8, wherein the combining further comprises:
using at least one transfer learning technique, by the one or more computer processors of the computer system, to determine best features from the individual layers to produce an output class with high accuracy.

14. The computer system of claim 8, further comprising:
comparing, by the one or more processors of the computer system, accuracy of the composite model relative to the accuracy of individual models of the plurality of supervised models.

15. A computer program product for transfer learning through composite model slicing, the computer program product comprising:
one or more computer readable storage media having computer readable program code collectively stored on the one or more computer readable storage media, the computer readable program code being executed by one or more processors of a computer system to cause the computer system to perform a method comprising:
receiving, by the one or more processors of the computer system, model data;
training, by the one or more processors of the computer system, a plurality of supervised models using the model data, each of the plurality of supervised models including a plurality of layers;
slicing, by the one or more processors of the computer system, each of the plurality of supervised models into individual layers of the plurality of layers;
calculating, by the one or more processors of the computer system, accuracy of feature detection of each of the individual layers of each of the plurality of supervised models; and
combining, by the one or more processors of the computer system, a sequence of the individual layers taken from different models of the plurality of supervised models into a composite model based on the calculated accuracy of feature detection of each of the individual layers of each of the plurality of supervised models.

16. The computer program product of claim 15, the method further comprising:
feeding, by the one or more processors of the computer system, the sliced individual layers into a neural network that outputs classes of different features that contribute to detection of an overall object.

17. The computer program product of claim 15, wherein the combining further comprises:
concatenating, by the one or more processors of the computer system, the sequence of the individual layers in an order that begins with low level features and ends with high level features.

18. The computer program product of claim 15, wherein the plurality of supervised models comprises different types of models, and wherein the combining further comprises:
combining, by the one or more processors of the computer system, the sequence of the individual layers from different types of models such that an output of a previous layer of the sequence of individual layers is not connected directly to an input of a next layer of the sequence of individual layers during training but is connected after the previous layer and the next layer are trained separately.

19. The computer program product of claim 15, wherein the combining further comprises:
using at least one transfer learning technique, by the one or more computer processors of the computer system, to determine best features from the individual layers to produce an output class with high accuracy.

20. The computer program product of claim 15, further comprising:
comparing, by the one or more processors of the computer system, accuracy of the composite model relative to the accuracy of individual models of the plurality of supervised models.
